(19) United States
(12) Patent Application Publication
(10) Pub. No.: US 2025/0170736 A1
(43) Pub. Date: May 29, 2025

(54) SHAVER

(71) Applicant: Wenzhou Xinsheng Electrical Appliance Co., Ltd, Wenzhou (CN)

(72) Inventor: Zhongmei CHEN, Wenzhou (CN)

(73) Assignee: Wenzhou Xinsheng Electrical Appliance Co., Ltd, Wenzhou (CN)

(21) Appl. No.: 18/396,337

(22) Filed: Dec. 26, 2023

(30) Foreign Application Priority Data
Nov. 25, 2023 (CN) 2023231886850

(51) Int. Cl. B26B 19/44; B26B 19/14

(52) U.S. Cl. CPC B26B 19/44; B26B 19/14

(57) ABSTRACT

Provided is a shaver, including a housing, a stationary blade portion, a movable blade portion, a power portion for driving the movable blade portion to rotate, and a power supply, where the shaver further includes a storage chamber used for storing beard residues and provided within the housing, a fan blade in transmission connection with the power portion, and a channel for the beard residues to flow to the storage chamber; a negative pressure generated by the rotation of the fan blade enables the beard residues to flow through the channel from the movable blade portion and enter the storage chamber. In the present utility model, a fan and an air duct are provided in the shaver, and the beard residues can be collected, thereby facilitating the treatment of the beard residues of the shaver.

### CROSS-REFERENCE TO RELATED APPLICATIONS

The application claims priority to Chinese patent application No. 2023231886850, filed on Nov. 25, 2023, the entire contents of which are incorporated herein by reference.

### TECHNICAL FIELD

This utility model belongs to the technical field of hair shaving tools, specifically a shaver.

### BACKGROUND

Currently, beard residues of the shaver are stored in the position of a movable blade and in the space between the movable blade and a power system. The beard residues are not easy to clean, and are accumulated around the rotating part of the power system, which may cause blockage of the rotating part of the power system, increase resistance and noise, and seriously burn out the motor of the power system, thereby causing losses.

### SUMMARY

The technical problem to be solved by the present utility model is how to collect beard residues of the shaver, reduce or prevent the beard residues from damage to the power system, and facilitate the treatment of the beard residues.

To achieve the above object, the present utility model provides the following technical solutions.

A shaver, comprising a housing, a stationary blade portion, a movable blade portion, a power portion for driving the movable blade portion to rotate, and a power supply, wherein the shaver further comprises a storage chamber used for storing beard residues and provided within the housing, a fan blade in transmission connection with the power portion, and a channel for the beard residues to flow to the storage chamber; a negative pressure generated by the rotation of the fan blade enables the beard residues to flow through the channel from the movable blade portion and enter the storage chamber, and a detachable cover for opening or closing the storage chamber is provided on the housing.

Preferably, a through hole is provided at the center of the fan blade, the fan blade is sleeved on a transmission shaft of the power portion and is in transmission fit with the transmission shaft, and the transmission shaft penetrates through the fan blade and is in transmission connection with a movable blade.

Preferably, the power portion comprises a gear set and a motor, the gear set is sealed between a first component and a second component, and after the first component and the second component are mounted, a space for the beard residues to pass through is provided as a whole or between the first component and the second component and the housing.

Preferably, support columns for maintaining the first component and the second component at a set distance are provided between the first component and the second component, and the support columns and the first component or the second component are of an integrated structure, or are fixedly connected to one of the first component and the second component in a separated manner.

Preferably, a space for accommodating the gear set is provided on a side of the second component facing the first component, the space is formed by a thin plate protruding from the second component towards the side of the first component, the shape enclosed by the protruding thin plate matches the shape of the first component, and a closed space is formed after the first component and the second component are mounted.

Preferably, the motor is provided within a closed accommodating box, and an output shaft of the motor extends to the outside of the accommodating box and penetrates through the first component and is in transmission fit with one of gears of the gear set.

Preferably, the accommodating box and the housing are of an integrated structure.

Preferably, a control module is connected to the bottom of the accommodating box, the control module is provided with a charging port and a control switch, and a socket corresponding to the positions of the charging port and the control switch is provided on the cover.

Preferably, the stationary blade portion and the movable blade portion have five cutters with one at the center and four at the periphery, and the four cutters at the periphery are inclined within a range of 6-15 degrees with the cutter at the center, and the outer edge position is a lifting end.

Preferably, the movable blade portion comprises movable blades, a supporting frame for supporting the movable blades, a blade holder moving up and down, and an elastic member used for elastically pushing the blade holder and provided between the blade holder and the supporting frame; the blade holder is mounted on the mounting positions of the movable blades on the supporting frame, the movable blades are provided between the blade holder and a stationary blade, the stationary blade portion is provided with pressing covers for pressing the stationary blade and a connecting frame for movably connecting the pressing covers, the pressing covers close to the edge position of the cutters are all connected to a shaft of the connecting frame, the pressing covers at the edge position rotate along the shaft, and a limiting mechanism for limiting the rotation angle of the pressing covers at the edge position is provided between the pressing covers at the edge position and the connecting frame or between the pressing covers at the edge position and the pressing cover at the middle.

The present utility model has the following beneficial effects: in the present utility model, a fan and an air duct are provided in the shaver, so that the beard residues can enter the storage chamber along the air duct, and thus the beard residues can be collected, thereby facilitating the treatment of the beard residues of the shaver, and also reducing damage to the power system caused by the beard residues.

### BRIEF DESCRIPTION OF DRAWINGS

FIG. 1 is a schematic diagram of an overall structure of the present utility model;

FIG. 2 is a structural exploded view of the present utility model;

FIG. 3 is a sectional view of the present utility model;

FIG. 4 is a structural schematic diagram of a housing of the present utility model;

FIG. 5 is a structural schematic view of a cover of the present utility model;

FIG. 6 is a schematic structural diagram of a first component;

FIG. 7 is a schematic structural view of a second component;

FIG. 8 is a schematic structural view of a fan blade;

FIG. 9 is a schematic structural diagram of a support frame;

FIG. 10 is a schematic structural view of a connecting frame;

FIG. 11 is a structural schematic diagram of pressing covers at the edge positions;

FIG. 12 is a schematic structural view of a pressing cover at the middle;

FIG. 13 is a structural schematic diagram of an elastic member;

FIG. 14 is a structural schematic diagram of a blade holder; and

FIG. 15 is a structural schematic diagram of a movable blade driving head.

### DETAILED DESCRIPTION OF THE EMBODIMENTS

The following clearly and completely describes the technical solutions in the embodiments of the present utility model with reference to the accompanying drawings in the embodiments of the present utility model. Apparently, the described embodiments are merely a part rather than all of the embodiments of the present utility model. All other embodiments obtained by a person of ordinary skill in the art based on the embodiments of the present utility model without involving creative efforts shall belong to the scope of protection of the present utility model.

### Embodiment

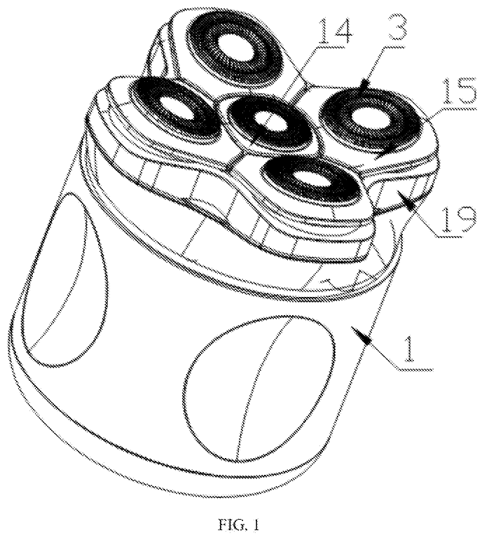

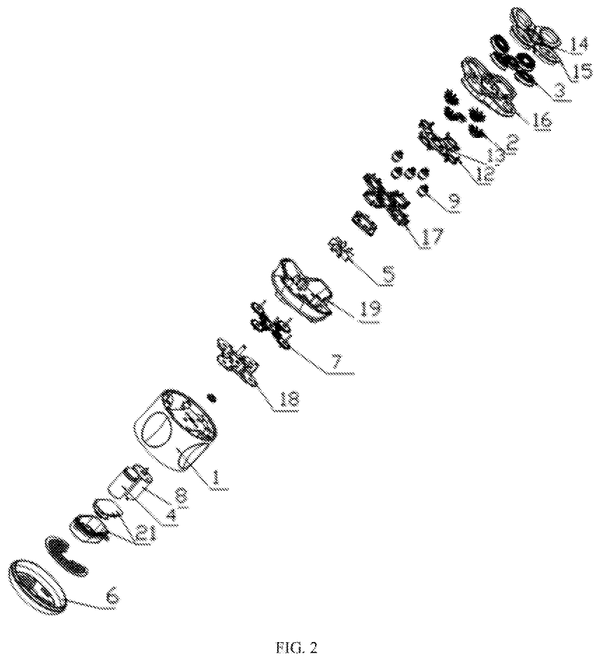

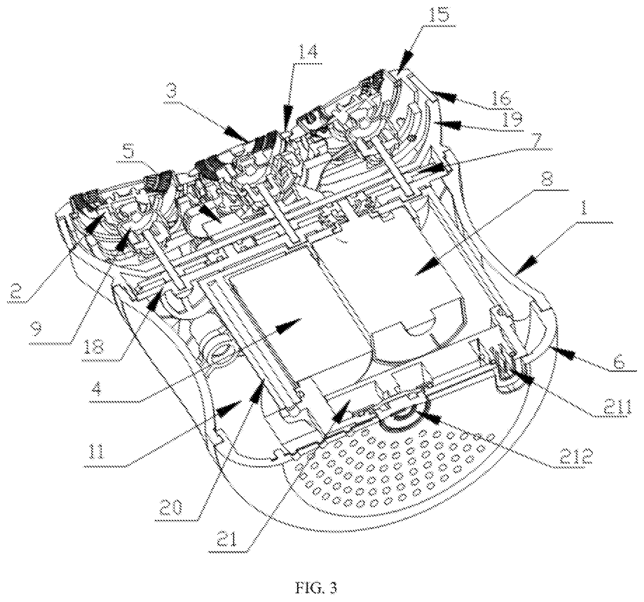

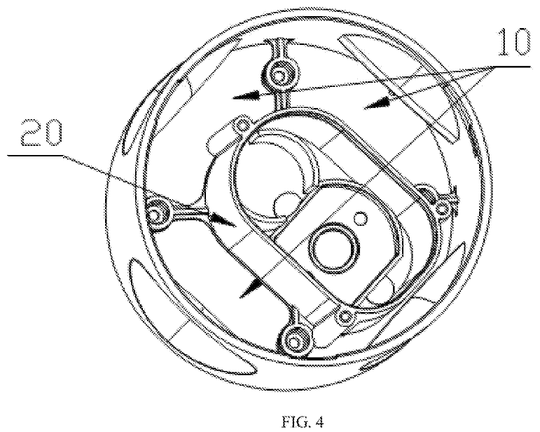

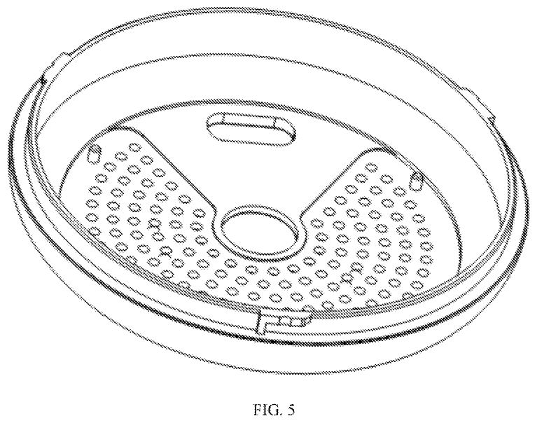

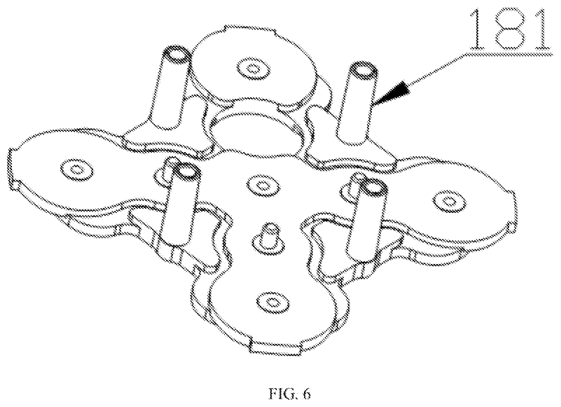

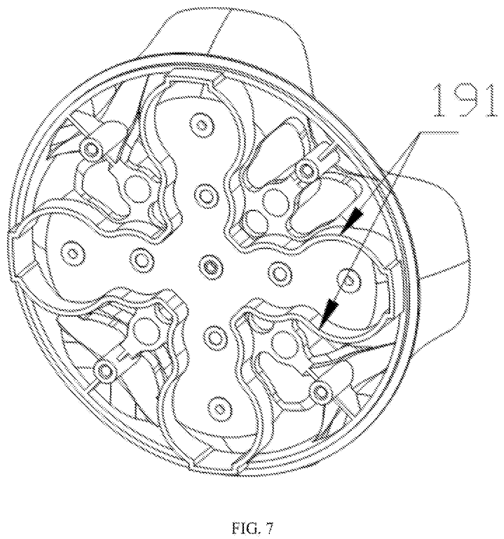

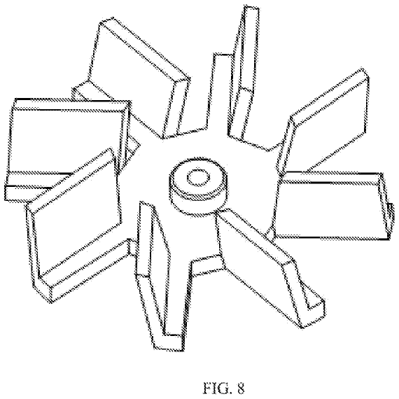

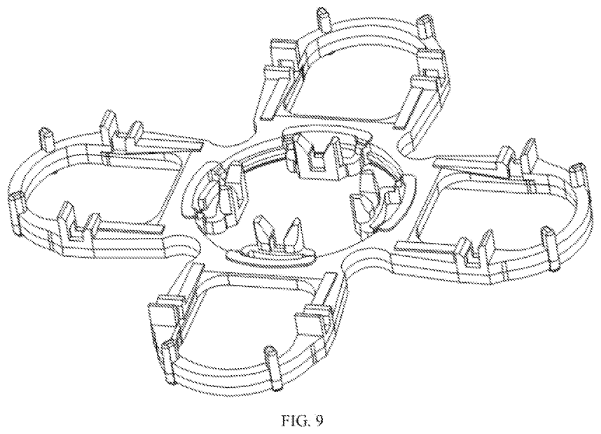

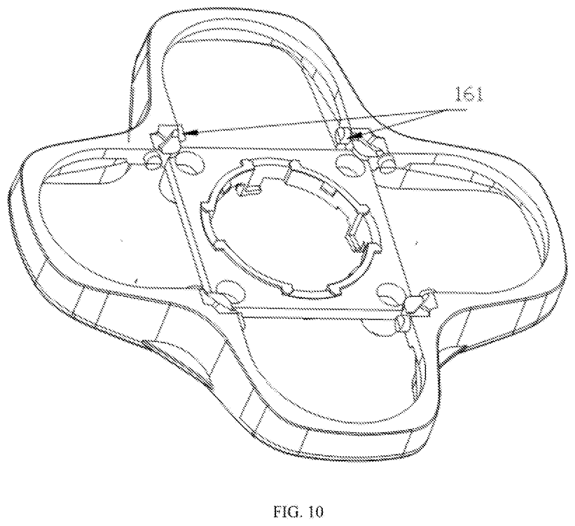

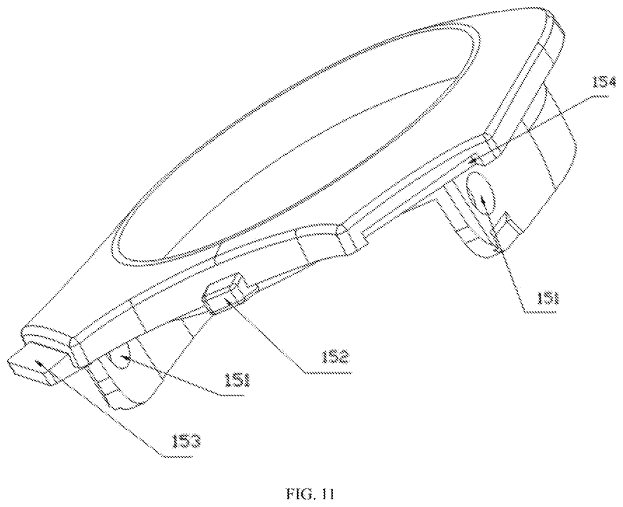

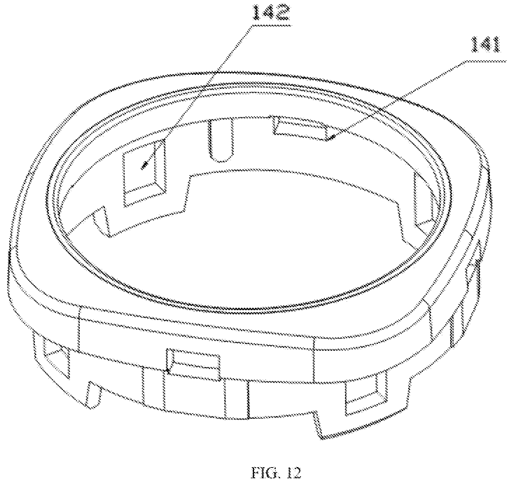

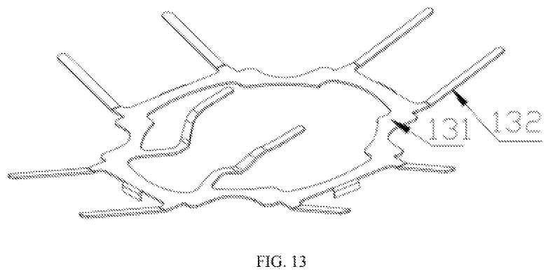

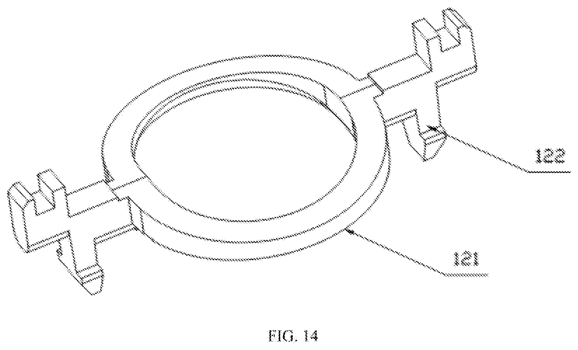

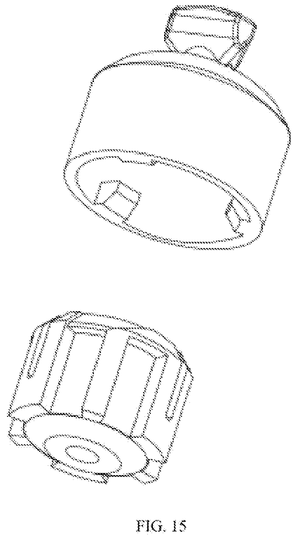

Refer to FIGS. 1 to 15, as shown in the figures, a shaver comprises a housing 1, a stationary blade portion, a movable blade portion, a power portion for driving the movable blade portion to rotate, and a power supply 4; the shaver further comprises a storage chamber 11 used for storing beard residues and provided within the housing 1, a fan blade 5 in transmission connection with the power portion, and a channel 10 for the beard residues to flow to the storage chamber; a negative pressure generated by the rotation of the fan blade 5 enables the beard residues to flow through the channel 10 from the movable blade portion and enter the storage chamber 11, and a detachable cover 6 for opening or closing the storage chamber is provided on the housing 1. In this embodiment, in order to facilitate the disassembly of the cover, the cover is in rotating snap-fit with the housing, and the structure is a rotary clamping structure commonly used in the market, which will not be described in detail here. In this embodiment, a through hole is provided at the center of the fan blade 5, the fan blade 5 is sleeved on a transmission shaft of the power portion and is in transmission fit with the transmission shaft, and the transmission shaft penetrates through the fan blade 5 and is in transmission connection with a movable blade 2.

The power portion comprises a gear set 7 and a motor 8, the gear set 7 is sealed between a first component 18 and a second component 19, and after the first component 18 and the second component 19 are mounted, a space for the beard residues to pass through is provided as a whole or between the first component and the second component and the housing 1; and the beard residues are sucked into the storage chamber 11 from the space by a suction force generated by the rotation of the fan. In order to enable the gear set 7 to operate normally, in this embodiment, support columns 181 for maintaining the first component 18 and the second component 19 at a set distance are provided between the first component and the second component, and the support columns 181 and the first component are of an integrated structure. In this embodiment, a space for accommodating the gear set 7 is provided on a side of the second component 19 facing the first component 18, the space is formed by a thin plate 191 protruding from the second component 19 towards the side of the first component 18, the shape enclosed by the protruding thin plate 191 matches the shape of the first component, and a closed space is formed after the first component 18 and the second component 19 are mounted, so that the gear set 7 is completely isolated from the beard residues, thereby ensuring that the beard residues does not affect the rotation of the gear set 7.

In the present embodiment, in order to completely isolate the power system from the beard residues, the motor 8 is provided within a closed accommodating box 20, the power supply 4 is a storage battery, the storage battery is also provided within the accommodating box 20, and an output shaft of the motor 8 extends to the outside of the accommodating box and penetrates through the first component 18 and is in transmission fit with one of gears of the gear set 7. The accommodating box 20 and the housing 1 are of an integrated structure. A control module 21 is connected to the bottom of the accommodating box 20, the control module 21 is provided with a charging port 211 and a control switch 212, and a socket corresponding to the positions of the charging port 211 and the control switch 212 is provided on a cover 6.

In this embodiment, the movable blade and the stationary blade are both prior art in the market, which are not described in detail herein. A movable blade driving head is provided on a lower end of the movable blade, an upper end of the movable blade driving head is inserted into a transmission groove of the movable blade; the movable blade driving head 9 comprises an upper portion and a lower portion, and the upper portion and the lower portion are axially movable and cannot rotate relative to each other. The present embodiment further comprises a supporting frame 17 for supporting the movable blade 2, a blade frame 12 moving up and down is provided on the mounting position of each movable blade 2 on the supporting frame 17, and the movable blade 2 is provided between the blade frame 12 and the stationary blade 3; an elastic member 13 for elastically pushing the blade holder 12 is provided between the blade holder 12 and the supporting frame 17; pressing covers for pressing the stationary blade 3 and a connecting frame 16 for movably connecting the pressing covers are provided on the housing portion 1. In this embodiment, the cutter head has five sub-cutters, one sub-cutter is arranged in the middle, and other four sub-cutters are annularly distributed in an array around the middle; each of the sub-cutters is provided with a pressing cover, the pressing cover 15 close to the edge position of the cutters are all connected to a shaft of the connecting frame 16, the pressing cover 15 at the edge position rotates along the shaft, a limiting mechanism for limiting the rotation angle of the pressing covers 15 at the edge position is provided between the pressing covers 15 at the edge position and the connecting frame 16 or between the pressing covers 15 at the edge position and the pressing cover 14 at the middle. After the pressing covers 15 at the edge position is connected to the connecting frame 16 by means of the shaft, one end of the pressing cover is limited by the limiting mechanism, so that one end of the pressing cover close to the edge position of the cutter is lifted upwards, forming a position close to the middle position lower than the edge position, making the whole cutter more easily adhere to the skin, thereby increasing the shaving area and making the shaving cleaner and quicker. In this embodiment, the driving head has no inclined angle, and only the upper portion of the movable blade 2 has an inclined angle, Because there is a gap between the driving head and the movable blade 2, the movable blade 2 is inclined by a little (if the inclined angle is too large, transmission cannot be implemented), and transmission can still be generated between the driving head and the movable blade 2. In this embodiment, the pressing covers 15 at the edge position, the stationary blade 3 at the edge position, the movable blade 2 at the edge, and the blade frame 12 at the edge position are inclined within a range of an angle of 8 degrees with respect to the plane where the pressing cover at the middle 14 is located, and the outer edge position is a lifted end; since the pressing cover is obliquely provided, the lower end of the movable blade 2 pushes the blade holder 12 by means of the elastic member 13, the movable blade 2 is always in close fit with the stationary blade 3, and the stationary blade 3 is also affected by the elastic force of the elastic member 13; Therefore, the pressing covers 15 at the edge position, the stationary blade 3 at the edge position, the movable blade 2 at the edge, and the blade frame 12 at the edge position are inclined with respect to the plane where the pressing cover at the middle 14 is located. Of course, the inclined angle can be in the range of 6-15 degrees; if the angle is too large, the transmission effect will be affected, and if the angle is too small, the technical effect of this embodiment cannot be achieved.

In this embodiment, the shaft between the pressing covers 15 and the connecting frame 16 is protruding columns 161 provided on an inner wall of the connecting frame 16 and protruding inwardly, the pressing cover is provided with concave holes 151 for clamping the protruded columns 161 on the connecting frame 16 and forming a relative rotation. The connecting frame 16 has a certain flexibility due to the material characteristics thereof; during mounting, the pressing covers are pressed by a force, so that the pressing covers are slightly deformed to force the concave holes 151 on the pressing covers to be clamped on the protruded columns 161 of the connecting frame 16. In this embodiment, an inclined guide surface is provided at the end portion of an upper portion of the protruded column 161, and the guide surface is also provided at a position corresponding to the lower end of the pressing cover located in the concave hole 151, thereby facilitating the fitting of the pressing covers and the connecting frame 16.

In this embodiment, the limiting mechanism is provided with a limiting groove 141 on the side surface of the pressing cover at the middle 14, and an inserting portion 152 extending into the limiting groove 141 is provided on the pressing cover 15 at the corresponding edge position.

In this embodiment, the elastic member 13 is a metal elastic sheet. The metal elastic sheet includes a mounting portion 131 and pushing portions 132. The mounting portion 131 is movably clamped on a supporting frame 17. Each of the pushing portion 132 extends to a lower portion of a blade frame 12, and also extend to a lower portion of the blade frame 12 at the middle. In this embodiment, the blade holder 12 comprises a supporting portion 121 and movable clamping portions 122, the supporting portion 121 is of a ring-shaped structure, a lower portion of the movable blade 2 is movably embedded in the ring-shaped structure, the pushing portion 132 of the elastic member 13 abuts against the bottom of the blade holder 12, and the clamping portions 122 are movably clamped on the supporting frame 17.

In this embodiment, the pressing cover at the middle 14 is movably fastened to the connecting frame 16, and after the pressing cover is fastened to the connecting frame 16, the pressing cover can reciprocate up and down on the connecting frame 16, and the movement range is limited by means of a fastening mechanism. The fastening mechanism comprises an elongated groove 142 provided on a side wall of the portion of the pressing cover at the middle 14 inserted into the connecting frame 16, the inner wall of the connecting frame 16 for the insertion portion 152 of the pressing cover at the middle 14 is provided with a positioning protrusion 162 clamped into the elongated groove 142 of the pressing cover at the middle 14; after the pressing cover 14 at the middle is inserted into the connecting frame 16, the positioning protrusion 162 is clamped in the elongated groove 142, and the movement of the positioning protrusion 162 is limited by means of the elongated groove 142, so as to limit the movement of the pressing cover at the middle 14 on the connecting frame 16.

In order to avoid creating a too large step feeling between adjacent pressing covers when shaving, in this embodiment, a linkage structure is provided between adjacent pressing covers 15 at the edge positions, the linkage structure comprises an extension plate 153 provided on the side of one of the pressing covers extending towards another pressing cover adjacent thereto, the pressing cover inserted by the extension plate 153 is provided with a slot 154 into which the extension plate 153 is inserted, and when one of the pressing covers is pressed during shaving, the adjacent pressing cover is inclined under the influence of the linkage structure.

What is claimed is:

1. A shaver, comprising a housing, a stationary blade portion, a movable blade portion, a power portion for driving the movable blade portion to rotate, and a power supply, wherein the shaver further comprises a storage chamber used for storing beard residues and provided within the housing, a fan blade in transmission connection with the power portion, and a channel for the beard residues to flow to the storage chamber; a negative pressure generated by the rotation of the fan blade enables the beard residues to flow through the channel from the movable blade portion and enter the storage chamber, and a detachable cover for opening or closing the storage chamber is provided on the housing.

2. The shaver according to claim 1, wherein a through hole is provided at the center of the fan blade, the fan blade is sleeved on a transmission shaft of the power portion and is in transmission fit with the transmission shaft, and the transmission shaft penetrates through the fan blade and is in transmission connection with the movable blade.

3. The shaver according to claim 1, wherein the power portion comprises a gear set and a motor, the gear set is sealed between a first component and a second component, and after the first component and the second component are mounted, a space for the beard residues to pass through is provided as a whole or between the first component and the second component and the housing.

4. The shaver according to claim 3, wherein support columns for maintaining the first component and the second component at a set distance are provided between the first component and the second component, and the support columns and the first component or the second component are of an integrated structure, or are fixedly connected to one of the first component and the second component in a separated manner.

5. The shaver according to claim 4, wherein a space for accommodating the gear set is provided on a side of the second component facing the first component, the space is formed by a thin plate protruding from the second component towards the side of the first component, the shape enclosed by the protruding thin plate matches the shape of the first component, and a closed space is formed after the first component and the second component are mounted.

6. The shaver according to claim 3, wherein the motor is provided within a closed accommodating box, and an output shaft of the motor extends to the outside of the accommodating box and penetrates through the first component and is in transmission fit with one of gears of the gear set.

7. The shaver according to claim 6, wherein the accommodating box and the housing are of an integrated structure.

8. The shaver according to claim 6, wherein a control module is connected to the bottom of the accommodating box, the control module is provided with a charging port and a control switch, and a socket corresponding to the positions of the charging port and the control switch is provided on the cover.

9. The shaver according to claim 1, wherein the stationary blade portion and the movable blade portion have five cutters with one at the center and four at the periphery, and the four cutters at the periphery are inclined within a range of 6-15 degrees with the cutter at the center, and the outer edge position is a protruding end.

10. The shaver according to claim 9, wherein the movable blade portion comprises movable blades, a supporting frame for supporting the movable blades, a blade holder moving up and down, and an elastic member used for elastically pushing the blade holder and provided between the blade holder and the supporting frame; the blade holder is mounted on the mounting positions of the movable blades on the supporting frame, the movable blades are provided between the blade holder and a stationary blade, the stationary blade portion is provided with pressing covers for pressing the stationary blade and a connecting frame for movably connecting the pressing covers, the pressing covers close to the edge position of the cutters are all connected to a shaft of the connecting frame, the pressing covers at the edge position rotate along the shaft, and a limiting mechanism for limiting the rotation angle of the pressing covers at the edge position is provided between the pressing covers at the edge position and the connecting frame or between the pressing covers at the edge position and the pressing cover at the middle.
